(19) United States
(12) Patent Application Publication
(10) Pub. No.: US 2016/0373408 A1
(43) Pub. Date: Dec. 22, 2016

(54) USB FIREWALL DEVICES

(71) Applicant: Adapt IP, Campbell, CA (US)

(72) Inventors: Strafford WENTWORTH, Saratoga, CA (US); Michael T.Y. MCNAMARA, Los Gatos, CA (US)

(21) Appl. No.: 14/746,335

(22) Filed: Jun. 22, 2015

(51) Int. Cl. H04L 29/06; G06F 21/44; G06F 13/40; G06F 13/20; G06F 13/42

(52) U.S. Cl. CPC H04L 63/0227; G06F 13/20; G06F 13/4282; G06F 13/4068; G06F 21/445

(57) ABSTRACT

USB firewall devices are disclosed that prevent unauthorized or unwanted access or communications from being passed between a host and a peripheral device that connects to the host via a USB port. The USB firewall devices can be interposed between a host and at least one peripheral device. In some examples, the USB firewall device can be a hub that can connect the host to a plurality of peripheral devices.

### BACKGROUND

Universal Serial Bus (USB) ports are widely used to operatively connect electronic devices. USB was designed to simplify the connection of computer peripherals by enabling the ability to plug a USB device into a computer host and have it automatically work, commonly referred to as “plug-and-play.” USB was introduced in the mid-1990s, and has since been extended and revised into a number of derivative standards, including at this point USB 1.0, USB 1.1, USB 2.0, USB 3.0 and USB 3.1. All of the revisions of the USB standard provide for the convenient connections of hosts to peripherals; in general the newer, higher numbered standards provide communication at higher speeds and with greater flexibility, while also providing backwards compatibility support of the earlier standards. In this document, USB refers to all of the various USB standards that have been introduced, as well as to subsequent standards that may be introduced, which operate similarly to the existing USB standards.

USB accomplishes the plug-and-play ability through various aspects of the USB standard. First, the USB standard provides a small set of common physical connectors that are used by a wide set of USB device classes. Non-limiting examples of USB device classes include: keyboards, mice, printers, and mass storage (commonly referred to as thumb drives, flash drives, or memory sticks). Second, the USB standard defines a single high-level protocol for identification and setup that is used by all USB devices. Because all USB devices support the same high level protocol, computers and other devices that act as hosts can be built with one or more USB ports, and the operating system in the host need only include a single generalized USB driver that can communicate and control all USB peripheral devices that may be connected to the host without needing foreknowledge of the exact class of device that is connected and which port it is plugged into. Third, the USB standard provides a standard peripheral device self-identification protocol. Specifically, USB defines a high level protocol that requires the host to “ask” a USB peripheral device to identify itself, such as by providing any of the following:

a. Device class—such as: audio, printer, hub, mass storage, human interface device (e.g., keyboard, mouse), video, etc.

b. Device sub-class—which provides additional specification detail within the USB device class (e.g., type of human interface device).

c. Protocols supported—which version of the USB protocol is supported.

Which device class/subclass protocol is supported.

d. A USB hardware vendor identifier—a unique ID for each vendor which is assigned by the USB-IF organization.

e. A product identifier—assigned by the USB vendor.

f. A product release identifier—assigned by the USB vendor.

g. A product serial number—assigned by the USB vendor.

The USB standard further provides for automatic installation of driver software. By requiring the host to “ask” the peripheral device to identify itself, the host obtains detailed information about the peripheral device. Using the device class, device subclass and vendor product information, the generalized USB host driver can search databases to identify and install the appropriate second level USB device driver.

However, the simplicity and convenience provided by USB introduces a security vulnerability.

Currently known virus protection methods are implemented in the host operating system using internal operating system policies, or by virus threat protection applications that run on the host operating system. Such approaches to virus protection can only provide limited protection in the USB domain, specifically versus USB application-level viruses. USB application-level viruses are a set of viruses that can be created using the published standard USB device class functionality or by using host operating system semantics built upon the standard USB device class functionality. One example of a type of USB application-level virus is the exploitation of operating systems that automatically trust and run a program when the user plugs in a USB thumb drive. Well-known viruses that use this technique include “Agent.bzt virus” and “SillyFDC virus.” As an example, in most versions of the Microsoft Windows operating systems (in this document called Windows OS), if there is a file named “Autorun.inf” in a directory of a removable file system, this file controls what programs are “automatically run” when the USB device providing the file system is opened by windows explorer. If “Autorun.inf” refers to a virus file, then when a USB drive is inserted into a computer the computer will automatically run the virus program. In order to mitigate this type of virus, some versions of the Windows OS will not automatically run programs unless your user preferences are set to allow it. Other versions of Windows OS force the user to make a choice to run this file. Another example of a type of USB application-level virus is associated with a file type on the USB drive. Operating systems are often configured to open files of a certain type only with a designated program. Often the operating system includes features to prevent a user from changing a file's type without a special password. A file with its type changed to cause a malicious behavior can be placed on a USB mass storage device. When a user inserts the USB mass storage device into an uninfected computer, the file will be opened by that targeted program, and will install its virus. These particular virus threats are not unique to USB devices, and are common to any removable storage, (such as SATA drives, Compact Flash, CDROM drives as well as USB drives) and existing operating system level virus blocking and scanning software is generally used to locate and eliminate these viruses.

However, the known virus protection methods do not protect against USB system-level viruses. USB system-level viruses are a set of viruses that leverage the implicit trust of USB system level specifications such as power management protocol, USB class/subclass protocols, or USB firmware, to cause malicious activities. For example, known virus protection methods do not protect against a virus-infected host infecting or reprogramming the firmware of a USB peripheral device. As another example, known virus protection methods do not protect a host against a USB peripheral device that contains malicious code within its USB class or contains hidden malicious USB classes. Such virus infected devices can self-identify as the expected USB device class and behave as expected when communicating under normal conditions and then switch to the malicious code and/or hidden malicious classes when the USB device determines that it is a “safe” time to enable the malicious code, for example when the system is booting and BIOS is in control or when the device calculates that the malicious activity will not be noticed.

USB system-level viruses can impact anyone using a USB connection. For example, a user that borrows a USB thumb drive from another person to transport data to or from their computer provides a pathway for viruses to be transmitted. As another example, a user who plugs their phone into an unknown USB port while away from home, in order to charge the battery, provides a pathway for virus transmission. With USB system-level viruses, the security threat is an integral part of how the USB standard was designed and how the USB protocol operates. The plug-and-play feature makes it easy for viruses to be transmitted. Additionally, the security threat operates in both directions. A malicious host computer can infect a “clean” and “uninfected” USB device. Contrariwise, a malicious USB device can infect a host computer, smart phone, or USB hub. Further, any class of USB devices could be the source or target of a USB virus, including for example, keyboards, mice, thumb drives, cameras, printers, scanners and smartphones. Virus scanning software cannot detect or remove these USB system-level viruses. The malicious code is hidden in a separate portion of the USB device and is activated only when enabled by the virus.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 illustrates one example of a USB firewall device of the present technology, with a host and a peripheral device.

FIG. 2 illustrates a second example of a USB firewall device of the present technology.

FIG. 3 illustrates a third example of a USB firewall device of the present technology.

FIG. 4 illustrates a fourth example of a USB firewall device of the present technology.

FIG. 5 illustrates one example of a method of operation of a USB firewall device of FIG. 4.

FIG. 6 illustrates one example of a method of determining whether an access or communication is authorized in a method of operation of FIG. 5.

FIG. 7 illustrates one method of selective modification in a method of operation of FIG. 5.

FIG. 8 illustrates a fifth example of a USB firewall device of the present technology.

### DETAILED DESCRIPTION

The present technology relates generally to USB firewall devices, which are designed to prevent unauthorized access or communications from being passed in either direction between a host and a peripheral device that connects to the host via a USB port. The term “virus” is used herein to refer generally to any such unauthorized access or communication, whether or not malicious. Connections between devices as discussed herein include operable connections, which allow for the flow of data, power related communication, and/or power between the connected devices. A connection could be directly between the host and the device, or could be indirect through one or more other devices, such as USB HUBs, between the host and the device. A connection can be wired or wireless, though for ease of visualization, wired connections are used in the illustrated examples.

A host can be any suitable computing device that can connect to another device via a downstream USB port. Some non-limiting examples of hosts include personal computing devices (e.g., desktop and laptop computers), mobile devices, smart phones, smart televisions, multi-function printers, video cameras, and automotive entertainment systems.

Peripheral devices for use with the present technology can be any device that connects to a host using an upstream USB port. Some non-limiting examples of types of peripheral devices include mass storage devices, USB Human Interface Devices (HID), smart phones, fitness trackers, basic printers, image scanners, music players, USB speakers, headsets, and charging devices. USB HID are a class of types of USB devices that provide input or output methods that physically interact with the user, where some non-limiting examples include: indicators, feedback mechanisms (via force, tactile or audio), keyboards, mice, trackballs, touch-pads, touch sensitive panels and game consoles.

The terms “upstream” and “downstream” are used herein (and also in the USB standards) to refer to the location of devices or ports connecting devices relative to the flow of data or power to and from the host computing device. As is generally understood in the art, upstream refers to the direction of flow towards the host, and downstream refers to the direction of flow away from the host. Accordingly, a host can have one or more downstream ports. And, an upstream port on a peripheral device can be connected to a downstream port of the host. Some devices include USB ports that can allow the device to act as a host in some scenarios, and as a peripheral device in other scenarios; these USB ports are commonly called ‘On-The-Go’ or OTG ports. As an example, a camera might have an OTG USB port. When a user plugs the upstream USB port of a USB mass storage device into the camera, the camera's operating system detects using the USB protocol that there is an upstream port connected to it, and so it configures the USB OTG port to act as a USB downstream port. The camera then acts as a host and the user can use the camera's operating system to transfer photographic files to the mass storage device. Alternatively, when the user plugs the camera's USB OTG port into a computing device's downstream USB port, then the camera's operating system detects using the USB protocol that it is connected to a downstream USB port, and so it configures the USB OTG port to act as an upstream USB port, and identifies as a mass storage device enabling the computers operating system to mount the camera and the user to access the camera as a peripheral mass storage device.

USB firewall devices of the present technology are physical devices that can be connected between a USB downstream port and a USB upstream port, (either which could be an USB OTG port) and that are designed and configured to prevent viruses from being passed between the host and the peripheral device, including USB system-level viruses. As used herein, the passage or flow refers to the transfer of power, power related communication, or data, and the passage or flow between two components encompasses transfers in either the upstream direction or the downstream direction. The flow of communication described herein includes such communication that traverses through one or more hub devices that might be between the host and peripheral device. The configuration of a USB firewall device can include physical structure permitting the flow of power or data between the downstream port of the USB firewall device and the upstream port the USB firewall device, and thus between the host and the peripheral device via the USB firewall device. The configuration of a USB firewall device can also include software, or executable instructions, specifically designed to facilitate the function of the USB firewall device. These instructions may be executed on a processor contained in the firewall device; or the instructions may be encoded as unchangeable hardware in the implementation of the firewall, thereby preventing the firewall itself from being infected with a virus.

USB system-level viruses fall into two classes: viruses initiated by the host and viruses initiated by the USB device. The host-based threat results from the fact that it is possible to reprogram the USB device firmware from the host. The USB device-based threat results from the fact that the host operating system implicitly trusts the USB device to properly identify their device class and to properly act as a device of that class. Additionally a device might operate sometimes as a host or a device by using an USB OTG port, and transmit and/or receive viruses by one or both mechanisms.

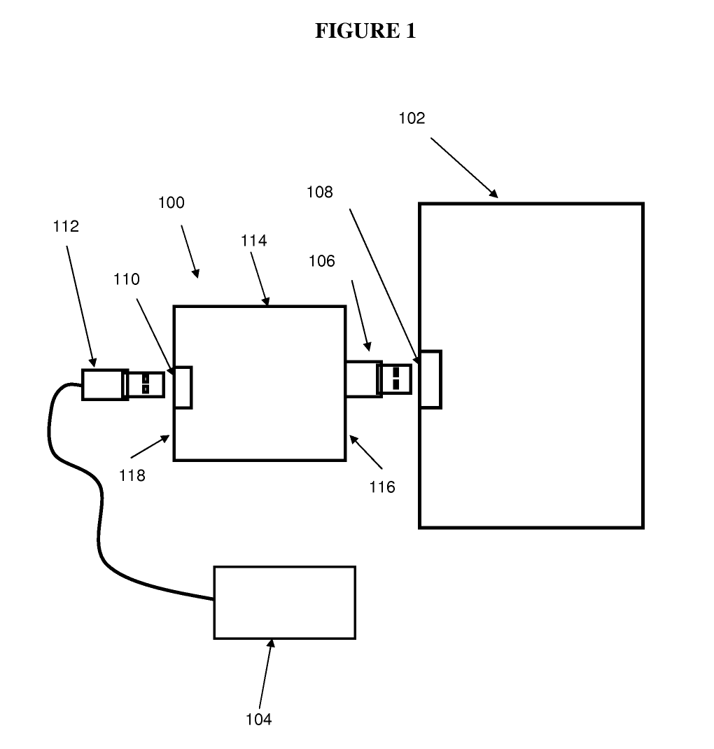

FIGS. 1-4 and 8 illustrate USB firewall devices of the present technology as a separate device with its own housing that is separate from the host computer. However, a USB firewall device of the present technology could be incorporated into the housing of the host, so that only the downstream port or ports are accessible to the user. Referring to the figures, examples of these downstream ports are identified as: 110, 204, 304, 404, 804, 806, 808, and 810. Thus, although the illustrated examples show the housing of the device as being separate from the housing of the host, the housing of the USB firewall device can also be the housing of the host.

FIG. 1 illustrates one example of a USB firewall device 100 of the present technology. The USB firewall device 100 can be used to connect a host 102 and a peripheral device 104. The USB firewall device 100 includes at least one upstream port 106 that is operatively connects to a downstream port 108 of the host 102. The USB firewall device 100 includes at least one downstream port 110 that operatively connects to an upstream port 112 of the peripheral device 104. The USB firewall device 100 can include a housing 114. As illustrated the at least one upstream port 106 and the at least one downstream port are accessible through the housing 114. As discussed above, however, in examples where the housing 114 of the USB firewall device is the same as the housing of the host 102, the at least one upstream port 106 can be located within the housing. As shown, the upstream port 106 can be located at a first end 116 of the housing 114, and the downstream port 110 can be located at a second end 118 opposite the first end 116, however, other arrangements of the upstream and downstream ports can be used.

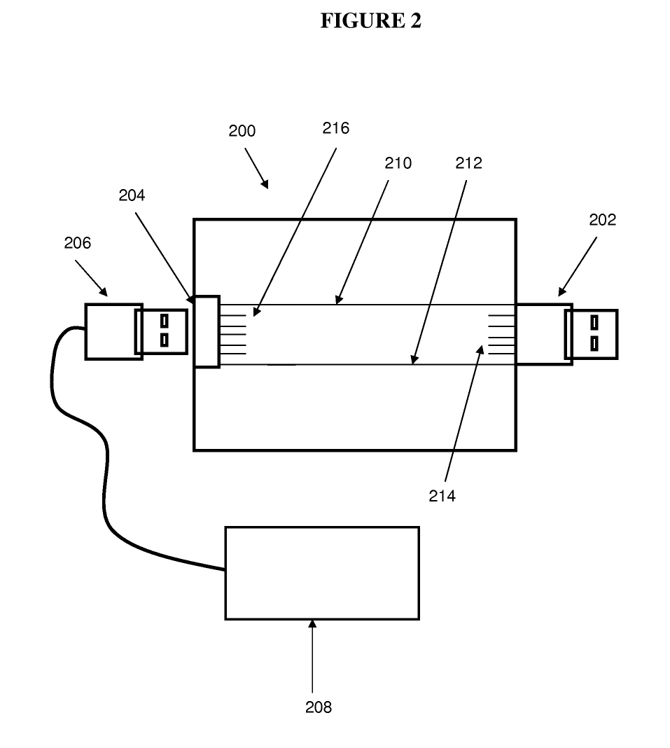

FIG. 2 illustrates one example of a USB firewall device 200 that is configured to permit only power and power related communication to flow between at least one downstream USB port to at least one upstream USB port, and thus between any host and peripheral device connected to the USB firewall device 200. The USB firewall device 200 includes at least one upstream port 202 that operatively connects to a downstream port of a host, such as downstream port 108 of host 102. The USB firewall device 200 includes at least one downstream port 204 that operatively connects to an upstream port 206 of a peripheral device 208. The USB firewall device 200 further includes a power wire 210, a ground wire 212, and any other wires that extend between and operatively connect the upstream port 202 and the downstream port 204 of the USB firewall device 200, that permit the flow of power and power related communication. However, USB firewall device 200 does not have signal wires that extend and operatively connect to the signal wire connections 214 and 216 of the upstream and downstream ports 202 and 204 and perform non-power related USB data communication.

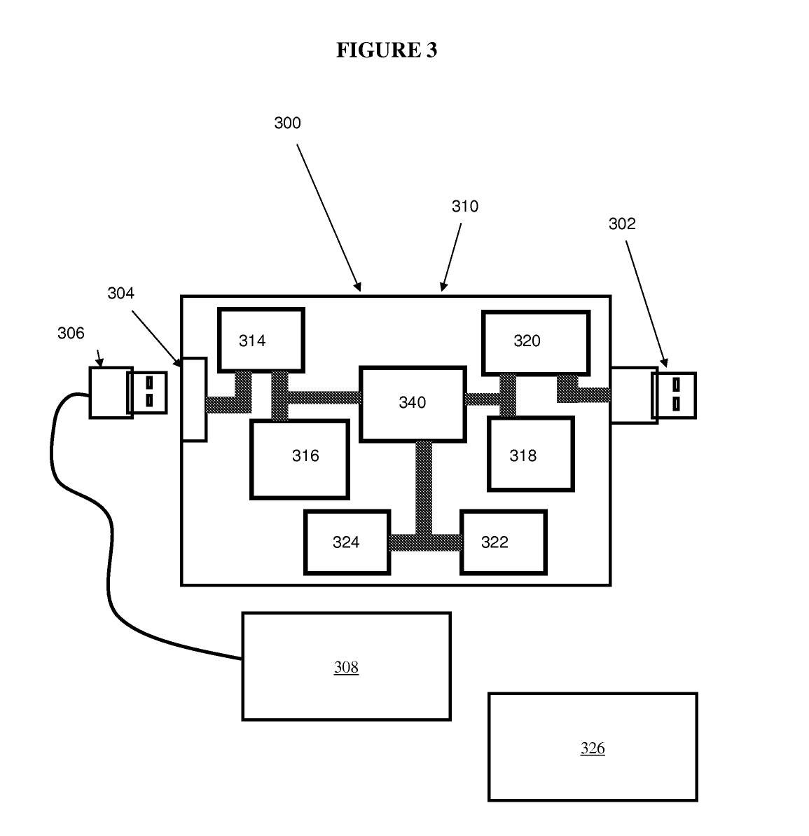

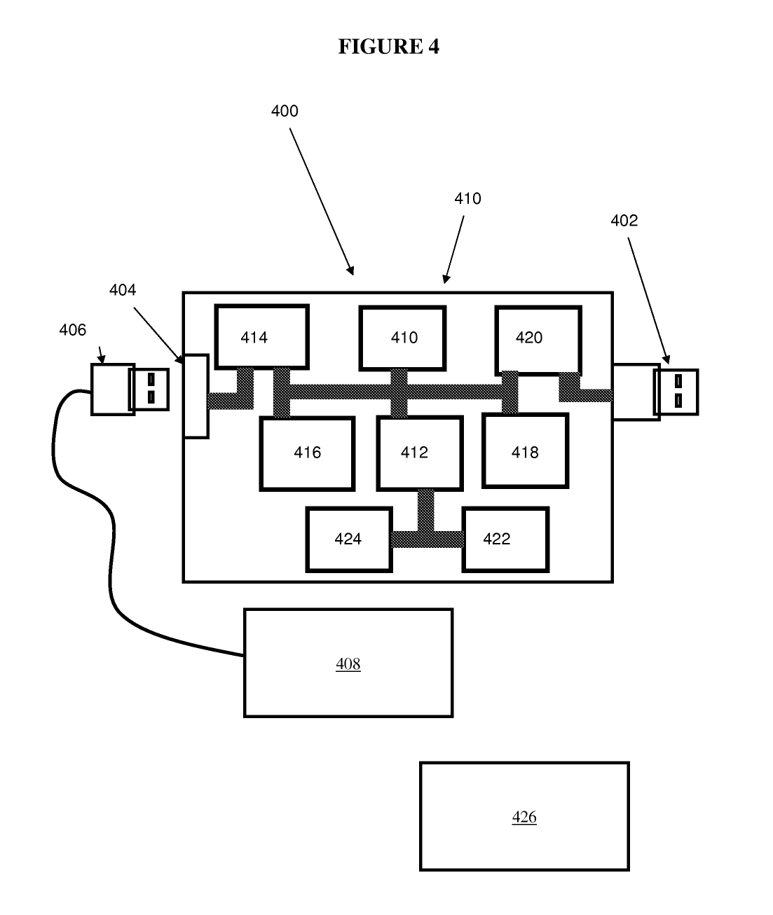

In other examples, USB firewall devices of the present technology include firewall security rules stored within the housing of the device that, when executed by the device cause the USB firewall device to determine whether the attempted access or communication is authorized, and prevent unauthorized communications from being passed between the host and the peripheral device. The firewall security rules can be in the form of executable instructions that can be stored in a memory of the USB firewall device and executed by a processor of the USB firewall device. Alternatively, the firewall security rules may be executed on a processor contained in the firewall device, or the instructions may be encoded as unchangeable hardware in the implementation of the firewall. Examples of such devices are illustrated in FIGS. 3 and 4.

FIG. 3 illustrates one example of a USB firewall device 300 that utilizes unchangeable hardware. The USB firewall device 300 of FIG. 3 includes at least one upstream port 302 that operatively connects to a downstream port of a host, such as downstream port 108 of host 102. The USB firewall device 300 also includes at least one downstream port 304 that operatively connects to an upstream port 306 of a peripheral device 308. Within housing 310, the USB firewall device 300 includes several components in the flow path between the downstream port 304 and the upstream port 302.

The security enforcement component 340 is an unchangeable hardware component that includes and executes the USB firewall security rules. The USB firewall security rules are coded in fixed logic in the security enforcement component 340. The security enforcement component 340 can analyze USB signal and data traffic, and/or the presence or absence of external security conditions, and can determine if an attempted access or communication is authorized by the USB firewall security rules. If an unauthorized access or communication is detected, the security enforcement component 340 can implement a security exception process to prevent the unauthorized access or communication from passing between the host and the peripheral device.

The components within housing 310 can also include a first physical link and interface 314, a USB host machine access controller (MAC) 316, USB device MAC 318, and a second physical link and interface 320. The first physical link and interface 314 receives data from, and transmits data to the peripheral device 308 according to the electrical specifications of the USB standard. The first MAC 316 accepts data received by the first physical link 314 and decodes these into packets including the device class and device type packets, and sends these to the security enforcement component 340; and it accepts packets from the security enforcement component 340 and sends them as data to the first physical link 314 for electrical transmission to the peripheral device 308. The second physical link and interface 320 receives data from, and transmits data to the host via the upstream port 302 according to the electrical specifications of the USB standard. The second MAC 318 accepts data from the second physical link 320 and decodes these into packets including device class and setup packets and sends these to the security enforcement component 340, and accepts packets from the security enforcement component 340 and sends them as data to the second physical link 320 for transmission to the host via the port 302. The security enforcement component 340 can indicate proper operation of the firewall, as a non-limiting example, shining a green lamp in indicator 322 if only permitted operations are occurring, and shining a red lamp in indicator 322 if forbidden operations have been attempted but have been stopped by the firewall. The security enforcement component 340 could communicate security violations to an external security monitor 326 using the communication device 324 which could operate wirelessly using any of a number of communication protocols.

FIG. 4 illustrates one example of a USB firewall device 400 that utilizes a memory and a processor. The USB firewall device 400 of FIG. 4 includes at least one upstream port 402 that operatively connects to a downstream port of a host, such as downstream port 108 of host 102. The USB firewall device 400 also includes at least one downstream port 404 that operatively connects to an upstream port 406 of a peripheral device 408. Within housing 410, the USB firewall device 400 includes several components in the flow path between the downstream port 404 and the upstream port 402.

These components include a memory 410 that stores USB firewall security rules, and a processor 412 that executes the USB firewall security rules. When executing the firewall security rules, the processor 412 can analyze USB signal and data traffic, and/or the presence or absence of external security conditions, and can determine if an attempted access or communication is authorized by the USB firewall security rules. If an unauthorized access or communication is detected, the processor 412 executing the firewall security rules can implement a security exception process to prevent the unauthorized access or communication from passing between the host and the peripheral device.

The components within housing 410 can also include a first physical link and interface 414, a USB host machine access controller (MAC) 416, USB device MAC 418, and a second physical link and interface 420. The first physical link and interface 414 receives data from, and transmits data to the peripheral device 408 according to the electrical specifications of the USB standard. The first MAC 416 accepts data received by the first physical link 414 and decodes these into packets including the device class and device type packets, and sends these to the processor 412; and it accepts packets from the processor 412 and sends them as data to the first physical link 414 for electrical transmission to the peripheral device 408. The second physical link and interface 420 receives data from, and transmits data to the host via the upstream port 402 according to the electrical specifications of the USB standard. The second MAC 418 accepts data from the second physical link 420 and decodes these into packets including device class and setup packets and sends these to the processor 412, and accepts packets from the processor 412 and sends them as data to the second physical link 420 for transmission to the host via the port 402. The processor 412 can indicate proper operation of the firewall, as a non-limiting example, shining a green lamp in indicator 422 if only permitted operations are occurring, and shining a red lamp in indicator 422 if forbidden operations have been attempted but have been stopped by the firewall. The processor 412 could communicate security violations to an external security monitor 426 using the communication device 424 which could operate wirelessly using any of a number of communication protocols.

The prevention of viruses (any unauthorized access or communication) from being passed between a host and a peripheral device connected to the USB firewall device incudes enforcing proper behavior for the USB host and USB device, which can be divided into two conceptual levels of protection.

The first level of protection can be accomplished by manufacturing the USB firewall device so that each of its one or more downstream ports only permits connection to peripheral devices of a predefined USB class/subclass. By establishing such a fixed configuration of the firewall, the firewall device, such as in the processor 412 of FIG. 4, or the security enforcement component 340 of FIG. 3, would only allow transmission of USB packets that are appropriate for the configured USB class. As an example, a USB firewall device might be manufactured to only allow the connection of an HID device such as a USB mouse. A user would insert the mouse's USB cable into the USB firewall device, and would also connect the USB firewall device to the host computer. The USB firewall device would prevent a malicious USB device from pretending to be the expected type of device, in this case, a mouse, and then later transforming its device type into an unexpected device type in order to perform malicious activities, as it would only ever allow the expected set of commands to traverse between the ports.

The second layer of protection can be provided by ensuring that both the host and the peripheral device operate properly (for the chosen USB device class/subclass set) and safely (as defined by the USB firewall security rules) during the entirety of their communication. For example, a USB firewall device might be manufactured to only allow connection of an IID device such as a USB keyboard device, and further include rules and hardware to prevent the communication of data between the keyboard and the host when an external security condition indicates that the authorized user is not present. Or for example, a USB firewall device could be constructed or configured to support USB mass storage devices in such a way as to enable these devices to be used for general storage, but disable these devices to be used as a boot device. In such instances, the USB firewall security rules could examine the protocol exchange to ensure that only commands approved by the firewall security rules were allowed to pass between downstream and upstream ports of the USB firewall device, and thus between the peripheral device and the host.

In some examples, the execution of the USB firewall security rules causes the USB firewall device to analyze data associated with any attempted access or communication between the host and the peripheral device to determine whether it is authorized. Such analysis can include analysis similar to what is commonly known as Deep Packet Inspection (DPI), also called complete packet inspection and Information eXtraction (IX). DPI depends on the automatic examination of the header and data of a packet, and is a form of computer network packet filtering commonly used in protecting against transmission of Internet viruses. In such examples, the component executing the firewall security rules (e.g., the processor 412 of FIG. 4, or the security enforcement component 340 of FIG. 3) functions as a packet inspection point, and examines the packet for protocol non-compliance, viruses, spam, intrusions, or defined criteria to decide whether the packet may pass on normally or if a firewall protected action is required.

Referring back to FIG. 1, when a USB firewall device of the present technology determines that there has been an attempted unauthorized communication from the host to the peripheral device or from the peripheral device to the host, it can halt the passage of the unauthorized communication between the downstream port 110 and the upstream port 106. The USB firewall device may also generate an error indication signal to provide an error indicator. For example, the processor 412 of FIG. 4 may transmit the error indication signal locally within the USB firewall device 400 to indicator lights 422, to the host connected to the upstream port 402, or wirelessly via a security notification device 424 to a site security monitor 426. Similarly in FIG. 3, the security enforcement component 340 may transmit the error indication signal locally within the USB firewall device 300 to indicator lights 322, to the host connected to the upstream port 302, or wirelessly via a security notification device 324 to a site security monitor 326.

The error indicator can be provided in any suitable manner. For example, with reference to FIG. 4, when the component executing the firewall security rules, in this case processor 412, can transmit the error indication signal locally within the USB firewall device 400, one example of an error indicator can be indicator light 422, which can be located on the housing 410 of the USB firewall device 400, and can be activated by the error indication signal transmitted by the processor 412. When the processor 412 transmits the error indication signal to the host, one example of an error indicator can be a window that appears, or pops up, on a screen of the host device to inform the user of the error. When the processor 412 transmits the error indication signal wirelessly, one example of an error indicator can be a message sent wirelessly by security notification device 424 to a site security monitor 426.

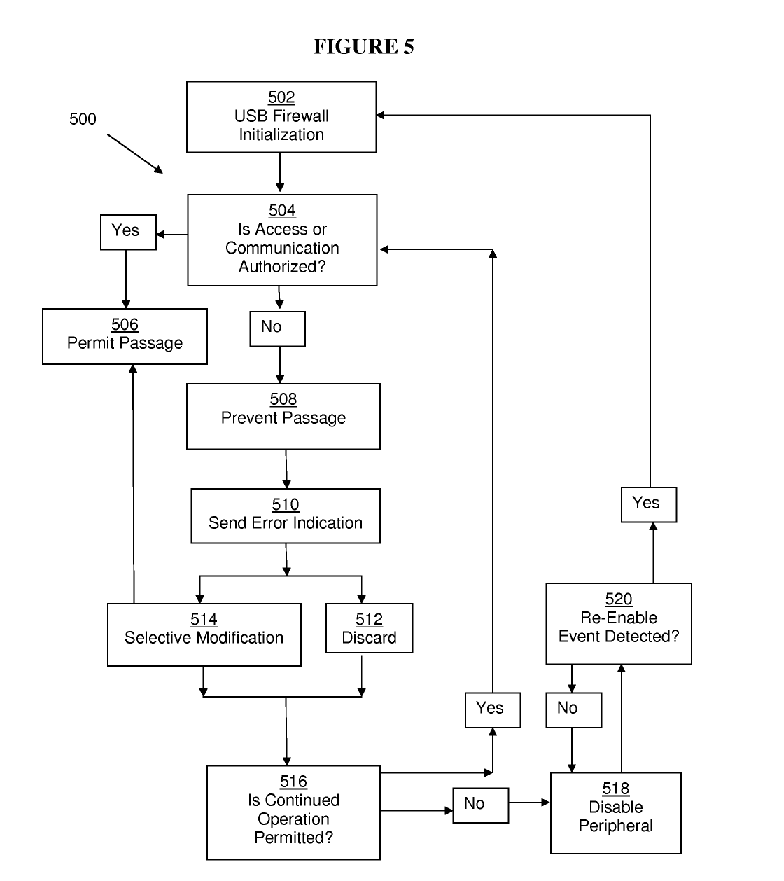

FIG. 5 is a flow chart describing one method of operation 500 of a USB firewall. For illustration purposes this method of operation is discussed with reference to a device 300 of FIG. 3 and a device 400 of FIG. 4. Once a USB firewall device 300 or 400 is connected to a host and a peripheral device, the method of operation 500 can begin. The method can be performed by the USB firewall device, operatively by the processor 412 of FIG. 4, or by the security enforcement component 340 of FIG. 3. In the first example, the processor 412 of FIG. 4 can execute the USB firewall security rules stored in memory, and the USB firewall security rules can cause the processor 412 to perform the steps of the method 500. In the second example, the security enforcement component 340 can execute the USB firewall security rules, and the USB firewall security rules can cause the security enforcement component 340 to perform the steps of the method 500.

As shown, the method of operation 500 starts at step 502, where the USB firewall device performs USB firewall initialization and then proceeds to the primary processing step 504, which is a step of determining whether an access or communication attempting to pass between a host connected to the USB firewall device and a peripheral device connected to the USB firewall device is authorized. If the attempted access or communication is authorized, the method can proceed to step 506, where the component executing the firewall security rules allows the attempted access or communication to pass from the host to the peripheral device or from the peripheral device to the host. If the attempted access or communication is not authorized, the method can proceed to step 508, where the component executing the firewall security rules performs a step of preventing the attempted access or communication from being passed between the host and the peripheral device.

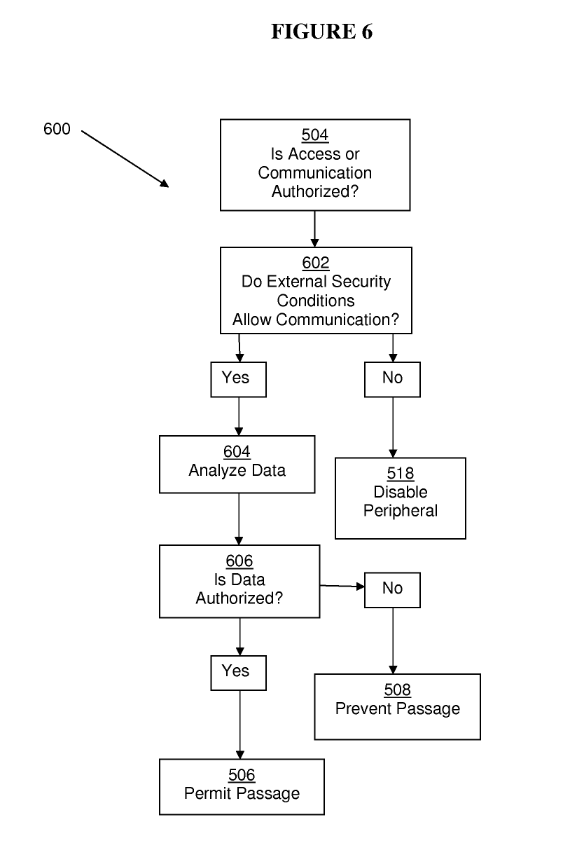

There are various processes that can be used for performing the determination step 504, including the process illustrated in FIG. 6. As shown in FIG. 6, the step of determining can include determination routine 600. Determination routine 600 includes step 604, in which the component of the device executing the firewall security rules performs a step of analyzing data being transmitted from the peripheral device to the host or from the host to the peripheral device, in accordance with the description above. At step 606, the component of the device executing the firewall security rules determines whether the data is authorized. If the data is authorized, the method can proceed back to step 506 of FIG. 5, and the attempted access or communication is permitted to pass. If the data is not authorized, the method can proceed back to step 508 of FIG. 5, and the attempted access or communication is prevented from passing.

Alternatively, or in addition to step 604, the step of determining can include step 602, in which the component of the device executing the firewall security rules performs a step of assessing whether a predefined security condition is met. In at least some examples, including the illustrated example, this step can be performed prior to the data analysis of step 604. If the external security condition is met, the method can proceed to step 604. If the external security condition is not met, the method can proceed to step 518 of FIG. 5, and the component of the device executing the firewall security rules can disable the peripheral device, as discussed further below.

One example of a predefined security condition can include unsafe electrical signal properties, such as: voltage out of range, voltage fluctuation outside of “safe” ranges defined by the USB firewall security rules. A second example of a predefined security condition can be an attempt by the peripheral device to change its peripheral device identification information away from an authorized USB device type. A third example of a predefined security condition can include unsafe USB Protocol commands or responses as defined by the USB firewall security rules, such as: data packets that are outside of the allowed range of the authorized USB device type. A fourth example of a predefined security condition can include the occurrence an external event as defined by the USB firewall security rules, such as:

A. a proximity indicator, which assures the firewall that the authorized user is present and using the computer host, is detected as no longer being present;

B. a specific host operating system events occurs, such as: user logout, or screen saver lock;

C. the connection to a wireless indicator, which is a proxy for an indicator that the user is near the host computer, is detected as being out of range or cannot be established; or

D. the current time is outside of the authorized time window.

Referring back to FIG. 5, optionally, when the USB firewall device determines that the attempted access or communication is unauthorized, the method can proceed to step 510, where the component executing the firewall security rules can optionally perform a step of sending an error indication signal to provide an error indicator as discussed above.

In some examples, when the USB firewall device determines that the attempted access or communication is unauthorized, the method can proceed to step 512, where the component executing the firewall security rules can prevent the unauthorized access or communication from being passed between the host and the peripheral device by performing a step of discarding the unauthorized access or communication.

Alternatively, when the USB firewall device determines that the attempted access or communication is unauthorized, the method can proceed to step 514, where the component executing the firewall security rules can perform a step of selectively modifying the data associated with the attempted access or communication to cause it to conform with what is authorized by the firewall security rules. The method can then proceed to step 506, allowing the modified data to pass between the host and the peripheral device.

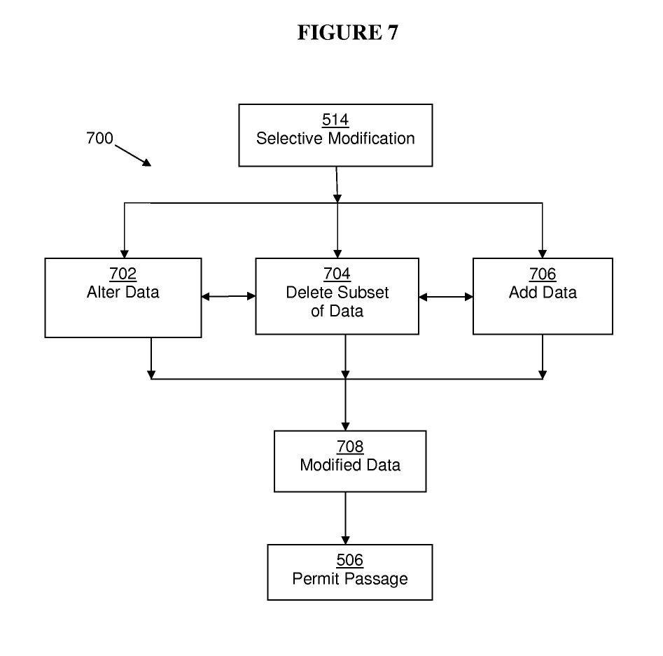

FIG. 7 illustrates one example of further steps that the method can perform as part of the selective modification of step 514. As part of step 514, the method can perform modification routine 700. The performance of modification routine 700 can include the performance of one or more of steps 702, 704 and 706. At step 702, the component executing the firewall security rules can perform a step of altering communication packets attempting to pass between the host and the peripheral device to cause the packets to be within the bounds of the firewall security rules. For example, peripheral device boot information may need to be obfuscated in order for a mass storage device to operate properly, while disabling the device boot feature. At step 704, the component executing the firewall security rules can perform a step of deleting a subset of the data attempting to pass between the host and the peripheral device that is outside the bounds of the firewall security rules. For example, a USB peripheral device may be a USB composite device, supporting both mass storage and printer device classes and the USB firewall rules for this device may only allow the USB printer class. Step 704 would then delete a subset of data passing between the host and the peripheral device to allowing printer related communication to pass and deleting mass storage related communication. Thereby allowing the composite device to operate as a USB printer, while preventing USB mass storage functionality. At step 706, the component executing the firewall security rules can perform a step of adding data into the communication stream between the host and the peripheral device that is within the bounds of the firewall security rules. For example, a USB peripheral device may be a mass storage device and the firewall security rules may present this device as a USB composite device supporting both the USB mass storage class and the USB firewall class of the present technology. By adding the USB firewall class information into the data stream between the USB firewall and the host computer, the host computer could recognize the USB firewall aspect of the composite device. This could allow for example the host computer to query the USB firewall to obtain error information.

Referring back to FIG. 5, whether or not the USB firewall device performs selective modification, the method can proceed to step 516 when the USB firewall device determines that the attempted access or communication is unauthorized. At step 516, the component executing the firewall security rules can perform a step of determining whether continued operation of the device is permitted. If the error is not severe or if modified data is to be transmitted, the USB firewall device can be permitted to continue operating, and the method can proceed back to step 504 for operation with respect to a subsequent attempted access or communication.

However if the error is severe, or if otherwise desired, continued operation of the USB firewall device may not be permitted until the device is re-enabled. In such instances, the method can proceed to step 518, where the component executing the firewall security rules can perform a step of disabling operation of the USB peripheral device after determining that the attempted access or communication is unauthorized. Disabling of the peripheral device can include, for example, ceasing to supply power and data to the peripheral device by automatically interrupting the connections of the wires. At step 520, the component executing the firewall security rules can perform a step of determining whether a re-enabling condition has been met as defined by the USB firewall security rules. The method can then loop between steps 518 and 520, until a re-enabling condition has been met. Examples of re-enabling conditions include:

1. a virtual or physical button or switch on said device is enabled;

2. a virtual or physical button or switch is enabled on a device that connects via wire or wirelessly to said device; or

3. a safe external condition occurs as defined by the USB firewall security rules, such as:
a. a proximity indicator, which assures the USB firewall that the authorized user is present and using the computer host, is detected as being present;
b. a specific host operating system events occurs, such as: user login, or screen saver unlock;
c. a wireless indicator is detected within range, which is a proxy for an indicator that the user is near the host computer; or
d. the current time is within the authorized time window.
   When a re-enabling condition is met, the component executing the firewall security rules can perform a step of re-enabling operation of the USB firewall device by proceeding to step 502 and reinitializing the USB firewall device.

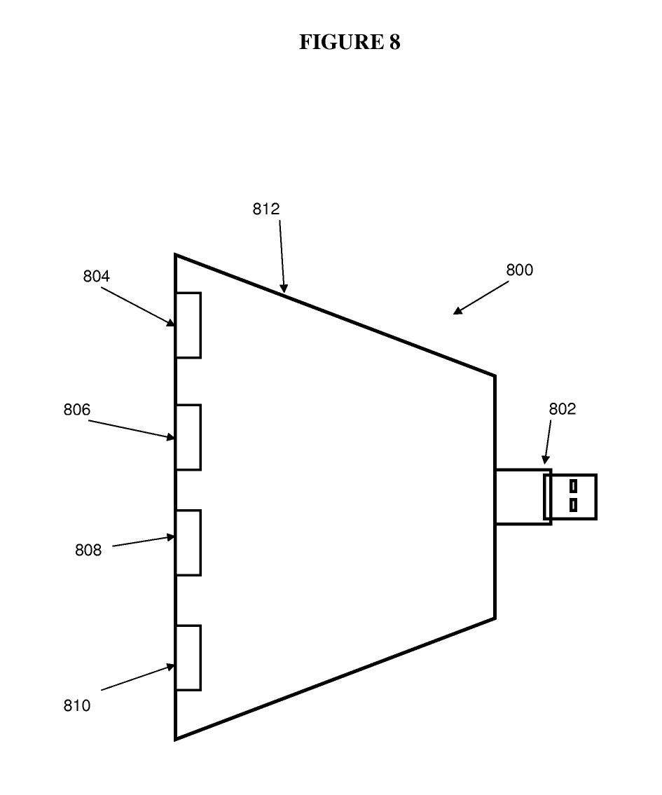

Some examples of USB firewall devices of the present technology can be USB hub devices. A USB hub provides a plurality of downstream USB ports that each connect the USB firewall device to a peripheral device. FIG. 8 illustrates one example of a USB firewall device 800 of the present technology that is a hub. The USB firewall device 800 has at least one upstream port 802 that operatively connects to a downstream port of a host, such as downstream port 108 of host 102. The USB firewall device 800 also includes a plurality of downstream ports 804, 806, 808, and 810 that can each operatively connect to an upstream port of a peripheral device, such as upstream port 112 of peripheral device 104, or may be connected to the upstream port of another hub. As illustrated, each of the downstream ports is located along one end of the USB firewall device 800, but other configurations of a hub can be used as well. For example, the plurality of downstream ports can be provided along any side or surface of the USB firewall device 800. In another example, each downstream port could be provided at the end of a cord or wire that extends from the USB firewall device 800.

Referring to FIG. 8, a USB firewall device 800 that is a hub can be configured to operate with peripheral devices of at least one USB class connected to one or more downstream ports of the hub. For example, a USB firewall device 800 that is a hub can be configured to permit operation with one or more of the downstream ports 804, 806, 808, and 810 being connected to a peripheral device of the same class. As another example, each downstream port of the hub 800 can be configured to operate more than one type of USB peripheral device. In such instances, a USB peripheral device that is connected to one of the downstream ports can be selected from a predetermined set of USB classes. Alternatively, each downstream port can be configured to operate with a specific class of USB peripheral device, which can be the same or different from the specific class of USB peripheral device of each other downstream port of the hub 800. In examples where different classes of USB devices can be connected to different downstream ports of the hub 800, each downstream port 804, 806, 808, and 810 could include an indicator, such as a label, color, or symbol that indicates what USB class or classes of peripheral device are permitted to be connected to that downstream port. In one example, the downstream ports could be color coded as follows: downstream port 804 could be purple and could be a micro-USB for use only to provide power; downstream port 806 could be yellow and could be configured in the USB firewall rules for use only with a USB mass storage device; downstream port 808 could be red and could be configured in the USB firewall rules for use only with a USB mouse; and downstream port 810 could be green and could be configured in the firewall rules for use only with a USB keyboard.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A USB firewall device comprising:
a housing;
at least one upstream USB port that operably connects the USB firewall device to a host; and
at least one downstream USB port that operably connects the USB firewall device to a peripheral device;
wherein the USB firewall device is configured to prevent unauthorized access or communications from being passed from the host to the peripheral device or from the peripheral device to the host.

2. The USB firewall device of claim 1, wherein the unauthorized access or communication comprises a USB system-level virus.

3. The USB firewall device of claim 1, wherein the USB firewall device is configured to permit only power and power related communication to flow between the at least one downstream USB port and the at least one upstream USB port.

4. The USB firewall device of claim 1, further comprising:
firewall security rules stored within the housing of the device that, when executed by the device, cause the USB firewall device to perform steps of:
determining whether an access or communication attempting to pass between a host connected to the USB firewall device and a peripheral device connected to the USB firewall device is authorized; and
preventing the attempted access or communication from being passed between the host and the peripheral device when it is unauthorized.

5. The USB firewall device of claim 4, further comprising:
a memory that stores the USB firewall security rules; and
a processor that executes the USB firewall security rules.

6. The USB firewall device of claim 4, further comprising a security enforcement component including the USB firewall security rules coded in fixed logic.

7. The USB firewall device of claim 4, wherein execution of the USB firewall security rules causes the device to prevent the unauthorized access or communication from being passed between the host and the peripheral device by discarding the unauthorized access or communication.

8. The USB firewall device of claim 4, wherein execution of the USB firewall security rules causes the device to perform a further step of sending an error indication signal.

9. The USB firewall device of claim 4, wherein the step of determining comprises analyzing data being transmitted from the peripheral device to the host or from the host to the peripheral device.

10. The USB firewall device of claim 9, wherein the firewall security rules cause the USB firewall device to perform a further steps of:
selectively modifying the data to produce modified data; and
allowing the modified data to pass between the host and the peripheral device.

11. The USB firewall device of claim 10, wherein the step of selectively modifying the data comprises:
altering communication packets attempting to pass between the host and the peripheral device to cause the packets to be within the bounds of the firewall security rules.

12. The USB firewall device of claim 10, wherein the step of selectively modifying the data comprises:
deleting a subset of the data attempting to pass between the host and the peripheral device that is outside the bounds of the firewall security rules.

13. The USB firewall device of claim 10, wherein the step of selectively modifying the data comprises:
adding data into the communication stream between the host and the peripheral device that is within the bounds of the firewall security rules.

14. The USB firewall device of claim 4, wherein the step of determining comprises assessing whether a predefined security condition is met.

15. The USB firewall device of claim 14, wherein the external security condition is selected from the group consisting of: unsafe electrical signal properties, attempt by the peripheral device to change its peripheral device identification information away from an authorized USB device type, unsafe USB Protocol commands or responses, occurrence of an external event, and combinations thereof.

16. The USB firewall device of claim 4, wherein execution of the USB firewall security rules causes the device to perform a further steps of:
disabling operation of the USB firewall device after determining that the attempted access or communication is unauthorized; and
re-enabling operation of the USB firewall device when a re-enabling condition is met.

17. The USB firewall device of claim 16, wherein the re-enabling condition is selected form the group consisting of: a virtual or physical button or switch on the USB firewall device is enabled, a virtual or physical button or switch is enabled on a device that connects via wire or wirelessly to the USB firewall device, and occurrence of a safe external condition.

18. The USB firewall device of claim 17, wherein the safe external condition is selected form the group consisting of: a proximity indicator is present, a specific host operating system events occurs, a wireless indicator is detected within range, and current time is within an authorized time window.

19. The USB firewall device of claim 1, wherein the USB firewall device comprises a plurality of downstream ports.
